(19) United States
(12) Patent Application Publication
(10) Pub. No.: US 2012/0200081 A1
(43) Pub. Date: Aug. 9, 2012

(54) CONNECTOR APPARATUS

(75) Inventors: Jason F. Reznar, Redford, MI (US); Michael Richard Danby, Stoney Creek (CA)

(73) Assignee: A. Raymond et Cie, Grenoble (FR)

(21) Appl. No.: 13/023,735

(22) Filed: Feb. 9, 2011

(51) Int. Cl. F16L 37/00; F16L 17/00

(52) U.S. Cl. 285/313; 285/345

(57) ABSTRACT

A connector apparatus is provided. In another aspect, at least a majority of a connector apparatus is a polymeric material. A further aspect of a connector apparatus couples together multiple tubes, which may optionally be of different materials. Yet another aspect employs a connector apparatus which can be of a quick connect variety to one or more tubes without requiring threaded engagement of the tube, thereby avoiding undesired thread stripping and/or thread misalignment.

### BACKGROUND AND SUMMARY

The present invention relates generally to a connector apparatus and more particularly to a connector that couples together multiple tubes.

Conventionally, various fittings, reducers and connectors have been used to couple together tubes, hoses and pipes (hereinafter, collectively referred to as “tubes”) which carry water, air or other fluid within a residential house, industrial factory, office building or the like. In one such example, a brass adaptor is brazed or soldered to copper tubes. However, new building codes are now requiring that no brazing, soldering or welding be conducted in an environment containing bottled oxygen or other highly flammable materials. Thus, conventional brass adaptors and couplings pose a problem when repair is required in a hospital, retirement home, laboratory or other such facility.

Another example of a conventional coupling is disclosed in U.S. Pat. No. 7,506,897 entitled “Plug-In Coupling for Connecting a Fluid Conduit to a Pipe” which issued to Bauer on Mar. 24, 2009. This patent is incorporated by reference herein. This conventional coupling, however, disadvantageously requires a male pipe to have a unique circumferential groove machined therein to engage a pair of spring legs. Thus, costs are increased and custom pipes are required.

In accordance with the present invention, a connector apparatus is provided. In another aspect, at least a majority of a connector apparatus is a polymeric material. A further aspect of a connector apparatus couples together multiple tubes, which may optionally be of different materials. Yet another aspect employs a connector apparatus which can be of a quick connect variety to one or more tubes without requiring threaded engagement of the tube, thereby avoiding undesired thread stripping and/or thread misalignment. Another aspect is constructed to allow for disengagement of an internally quick connected tube within the connector assembly. A method of connecting multiple tubes with a connector is also provided.

The connector assembly of the present invention is advantageous over conventional devices. For example, the present connector assembly does not require brazing, soldering, welding or other such heating for connection to the tubes. Furthermore, the present connector assembly allows for quick and secure coupling together of multiple tubes. Unlike with some traditional fittings, the present connector assembly does not require threading of the tubes or of fittings to be applied thereto. Easy disassembly of the connector is also provided. Moreover, unique attachment formations, characteristics or grooves are not needed on the connected tubes such that inexpensive standard tubes are employed. Additional advantages and benefits of the present invention are shown in the associated figures, and disclosed in the following description and appended claims.

### BRIEF DESCRIPTION OF THE DRAWINGS

FIG. 1 is a fragmentary perspective view showing a connector assembly installed in a building;

FIG. 2 is an exploded perspective view showing a first preferred embodiment of the connector apparatus;

FIG. 3 is a longitudinal sectional view showing the first preferred embodiment connector apparatus coupling together a pair of tubes;

FIG. 4 is a longitudinal sectional view showing a second preferred embodiment of a portion of the connector apparatus;

FIG. 5 is a perspective view showing a portion of the connector apparatus; and

FIG. 6 is a perspective view showing an alternate embodiment of the connector apparatus.

### DETAILED DESCRIPTION

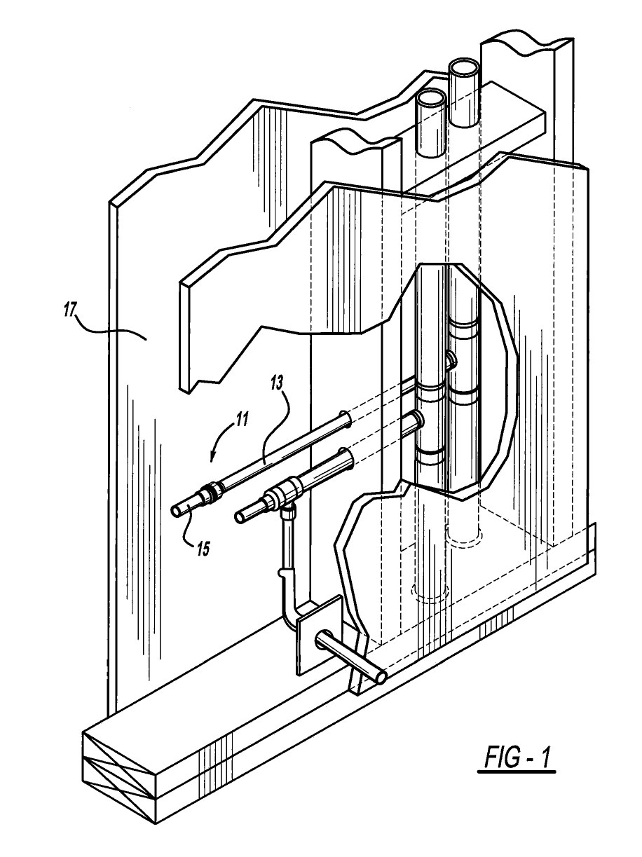

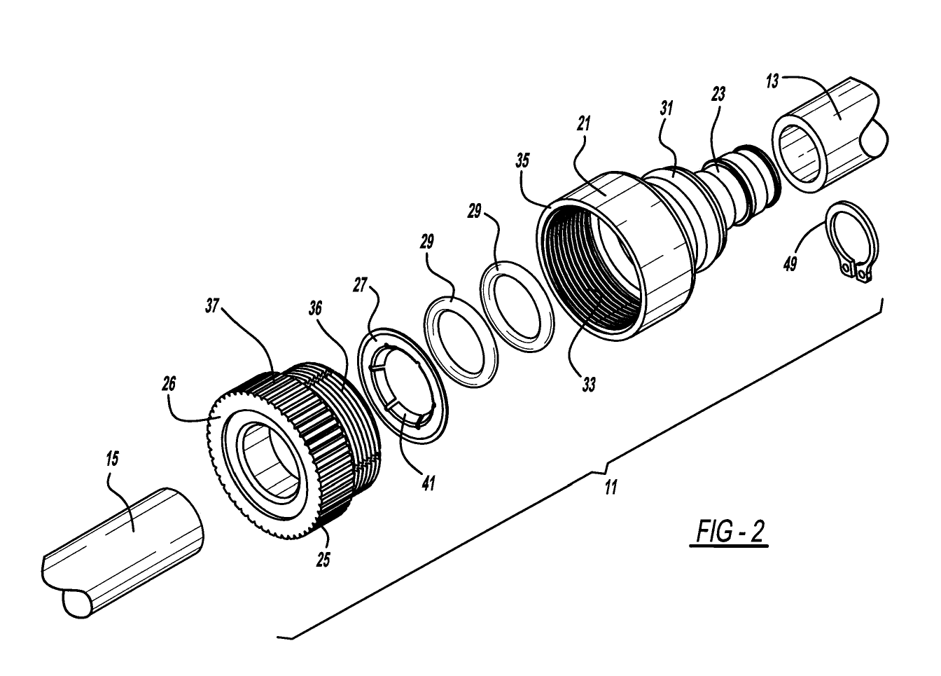

Referring to FIGS. 1 and 2, a connector 11 couples together a first tube 13 to a second tube 15. In a preferred use, the tubes are part of a fluid carrying plumbing system, such as for water, within a health care or laboratory facility, and mounted between walls 17, floors or ceilings thereof. Tube 13 is preferably a PEX, cross-linked polyethylene and somewhat flexible member while tube 15 is preferably a generally rigid copper pipe.

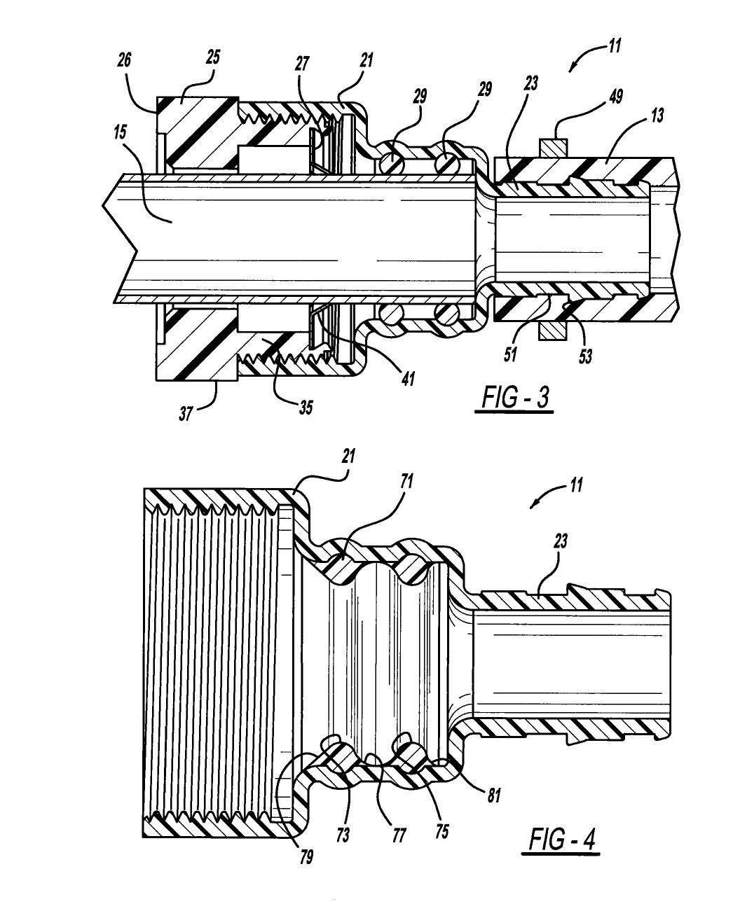

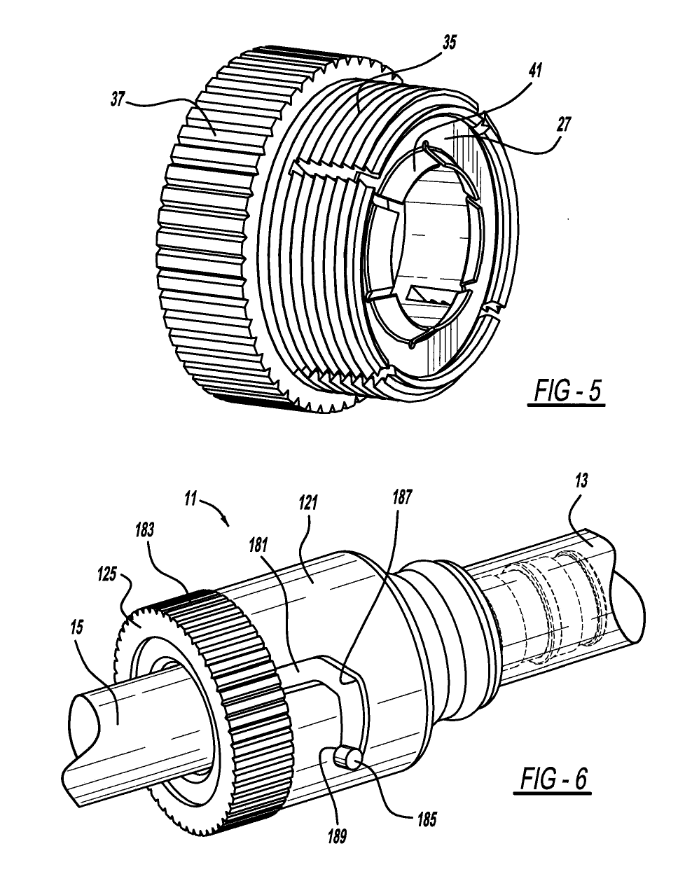

As best seen in FIGS. 2, 3 and 5, a first preferred embodiment of connector 11 includes a circular body 21 from which extend a male adaptor 23. Connector 11 further includes a collar 25, a metallic retainer 27 and multiple O-ring seals 29. All of the components 21-29 of connector 11 have hollow through-bores that are coaxially aligned when assembled together. Body 21 and adaptor 23 are formed as an integral, single piece. Body 21, adaptor 23 and collar 25 are all preferably an engineering grade polymeric material, such as a glass-filled nylon or the like.

An intermediate section 31 of body 21 contains a pair of circumferentially enlarged and internal pockets within which are secured seals 29. An attachment feature of body 21 includes an internal thread 33 adjacent a female end 35 thereof. An externally threaded attachment feature 36 of collar 25 enmeshes with threads 33 to removably attach collar 25 to body 21. An enlarged diameter flange 37 of collar 25 includes an externally accessible groove or knurl pattern to allow manual or tool gripping and rotation of collar 25 relative to the body for attachment and detachment therebetween. Multiple relief slots are provided within the threaded segment of collar 25 to allow some flexure thereof.

Retainer 27 is preferably stamped from a sheet of carbon spring steel. There are at least two, and more preferably six, teeth 41 that inwardly extend from a continuous circular ring of retainer 27. Each tooth 41 is bent at an offset angle from a nominal plane of the outer ring and each tooth is chamfered to point generally toward male adaptor 23 of connector 11. Collar 25 serves to secure retainer 27 within body 21 when the connector is fully assembled. Alternately, an entirely annular, spring steel retainer can be used which includes a contiguous inside circle on the forwardly offset angled ring segment; the inside circle has a tapered end defining a through-bore, which engages the copper tube in an interference fit manner. It is noteworthy that both retainer embodiments engage at least a majority of a circumference of the inserted tube.

Connector 11 is preassembled such that collar 57, retainer 27 and seals 29 are attached together when the connector is manufactured and prior to shipment to an installer such as a plumber. Thereafter, metallic tube 15 is linearly inserted into the through-bore of a female end 26 of collar 25 until the tube abuts at the transition between body 21 and male adapter 23. This allows seals 29 to engage with and compress against an external surface of tube 15. A low insertion effort, such as approximately 17 or less pounds, is required to manually insert tube 15 through retainer 57. Teeth 41 of retainer 27, however, bite into the exterior surface of tube 15 and require approximately 200-400 pounds or more of extraction force, thereby significantly deterring undesired disassembly. This provides a quick connect feature. A constant circular-cylindrical external section of the tube, free of grooves, threads or localized formations, is engaged by the teeth. Notwithstanding, tube 15 can be easily uncoupled from connector 11 by a person manually unscrewing collar 25 from body 21.

At the other end, a metal cir-clip fastener 49 or the like can optionally be used to secure and clamp the otherwise cylindrical end of tube 13 around male adapter 23 after they have been squeezed together. In this situation, fastener 49 inwardly compresses an internal surface of tube 13 to engage within circumferentially expanded and reduced formations on the outside surface of male adapter 23. For example, a set of circular valleys 51 and adjacent circular peaks or barbs 53, are present in the outside of male adapter 23. At least one valley 51 is at least as wide as the generally concentric fastener 49. This serves to deter undesired removal of tube 13 from connector 11.

FIG. 4 illustrates a second preferred embodiment of connector 11. Body 21 and male adapter 23 are essentially the same as that of the first preferred embodiment; however, the seal configuration is different. With the present embodiment, seal 71 has a generally unified annular shape internally defined by a pair of raised sealing peaks 73 and 75 joined together by a bridging valley 77. Additionally, tapered tails or ends 79 and 81 project from peaks 73 and 75, respectively, to maintain the desired peak orientation and position within the body.

An alternate embodiment connector 11 is shown in FIG. 6. This connector is essentially the same as that of the preferred embodiments, except that no threads are provided to attach together a collar 125 and a body 121. Instead, collar 125 includes a circular-cylindrically smooth male segment 181 of smaller diameter than a grooved flange 183. An attachment pin 185 radially projects from segment 181 of collar 125 and rides along an attachment channel or slot 187 within body 121. Channel 187 has a multi-angled shape to allow for linear and twisting motion of collar 125 relative to body 121. Additionally, a slight detent 189 is located near an end of channel 187 to secure pin 185 thereat. This provides a non-threaded attachment feature between collar 125 and body 121, while also allowing for easy uncoupling thereof. Alternately, the pin and channel may be reversed between the collar and body.

While various embodiments of the present connector apparatus have been disclosed, it should be appreciated that other variations are possible. For example, the connector may be made of other materials although many of the present advantages will not be achieved. Furthermore, the retainer can alternately be a polymeric material as long as the insertion and extraction forces, and durability are suitable. Moreover, it is envisioned that the present connector can be employed in other industries, such as connecting together automotive vehicle tubes, airplane tubes, watercraft tubes, robotic and machinery tubes, and the like; however, various advantages may not be realized. It is additionally intended that the attachment feature connecting the collar to the body can use flexible snap fits, a removable cotter pin, or the like although certain benefits may not be utilized. Alternately, the enlarged flange of the collar can have a hexagonal or other polymeric peripheral shape when viewed from its end, to easily mate with a wrench or other tool. The description of the invention is merely exemplary in nature and, thus, variations that do not depart from the gist of the invention are intended to be within the scope of the invention. Such variations are not to be regarded as a departure from the spirit and scope of the present invention.

The invention claimed is:

1. A tube-to-tube connector apparatus comprising:
a hollow and polymeric body;
a seal located within the body;
a hollow and polymeric male adaptor extending from the body, the male adaptor having a substantially circular periphery cross-sectionally smaller as compared to the body; and
a retainer located within and coupled to the body, the retainer including a central aperture defined at least in part by a plurality of inwardly and forwardly projecting tube-engaging teeth.

2. The connector apparatus of claim 1, further comprising:
a first tube directly attached around an outside of the male adaptor which is free of threads; and
a second tube internally attaching within the aperture of the retainer and engaging with the seal inside the body, the section of the second tube located in the body being cylindrical and free of unique attachment formations.

3. The connector apparatus of claim 2, wherein at least one of the tubes is metallic.

4. The connector apparatus of claim 2, wherein the first tube is polymeric and the second tube is metallic, further comprising a fastener securing the first tube to the male adaptor.

5. The connector apparatus of claim 2, wherein the teeth of the retainer are configured to allow the second tube to be easily inserted into the body but resist removal of the tube from the body when the retainer is secured to the body, the plurality of teeth including at least four teeth inwardly projecting from an annular ring entirely located internally within the body.

6. The connector apparatus of claim 1, further comprising a hollow and polymeric collar removably coupled to the body, the collar acting to secure the retainer within the body when the collar is attached to the body, and the collar allowing removal of the retainer from the body when the collar is detached from the body by a rotational movement, at least a section of the collar being located within the body.

7. The connector apparatus of claim 6, wherein the male adaptor is integral with the body as a single piece, the retainer is metallic, and hollow bores through the collar, body and adaptor are all coaxially aligned.

8. The connector apparatus of claim 6, further comprising threads disengageably attaching the collar to the body, disengagement of the collar allowing a tube to be disconnected from the body.

9. The connector apparatus of claim 6, further comprising a pin sliding along a channel disengageably attaching the collar to the body, disengagement of the collar allowing a tube to be disconnected from the body.

10. A tube-to-tube connector apparatus comprising:
a polymeric adaptor including a through-bore and an exterior surface, the exterior surface being defined by enlarged and reduced circumference configurations;
a polymeric body including a through-bore, the body further including an attachment feature;
a seal located within the body;
a polymeric collar including an attachment feature disengageably attaching with the attachment feature of the body through at least rotational movement, part of the collar being internal to the body and part of the collar being externally accessible from beyond the body in all assembled conditions.

11. The connector apparatus of claim 10, further comprising a tube-receiving retainer secured within the body by the collar, the retainer including a plurality of inwardly projecting teeth.

12. The connector apparatus of claim 11, further comprising:
a first tube directly attached around the exterior surface of the adaptor; and
a second tube having a constant cylindrical end section internally attached within an aperture of the retainer and engaging with the seal inside the body.

13. The connector apparatus of claim 12, wherein at least one of the tubes is metallic.

14. The connector apparatus of claim 12, wherein the first tube is polymeric and the second tube is metallic, further comprising a fastener securing the first tube to the adaptor.

15. The connector apparatus of claim 11, wherein the teeth of the retainer are configured to allow a tube to be easily inserted into the body but resist removal of the tube from the body as long as the retainer is secured to the body, the plurality of teeth including at least four chamfered teeth inwardly projecting from an annular ring.

16. The connector apparatus of claim 10, further comprising a circumferentially enlarged pocket internally located within the body, the seal being located within the pocket.

17. The connector apparatus of claim 10, wherein the attachment feature further comprises:
a multiple angled channel located in one of: the body and the collar; and
a projection radially extending from an exterior surface of the other of: the collar and the body, the projection sliding within the channel;
wherein insertion and rotation of the collar relative to the body causes the projection to move along the length of the channel such that the projection-to-channel engagement disengageably couples together the collar to the body.

18. The connector apparatus of claim 10, wherein the attachment features further comprise mating threads.

19. A connector assembly comprising:
(a) a polymeric connector comprising a hollow body and a hollow male adaptor extending from the body, and a hollow annular member rotatably coupled to the body adjacent an end opposite the adaptor;
(b) a retainer entirely located within the body, the retainer including an outer circular ring within which is a central aperture, at least four projections inwardly extending from the ring;
(c) a first tube attached to the male adaptor; and
(d) a second, metallic tube having a constant cylindrical section attached to the projections of the retainer and located internally within the hollow of the annular member.

20. The connector assembly of claim 19, further comprising a fastener, wherein the first tube is polymeric which is held to surround the adaptor by the fastener, an outside surface of the adaptor having a convoluted and irregular shape with a valley at least as wide as the fastener.

21. The connector assembly of claim 19, wherein the projections of the retainer are angled somewhat toward the adaptor and are configured to allow the second tube to be easily and linearly inserted into the body but resist removal of the tube from the body as long as the retainer is secured to the body.

22. The connector assembly of claim 19, wherein the member secures the retainer within the body when the member is attached to the body, and the member allows removal of the retainer from the body when the member is detached from the body, one section of the member being located within the body and a second section of the member being located outside of the body when assembled together.

23. The connector assembly of claim 19, further comprising threads disengageably attaching the member to the body, disengagement of the member allowing the second tube to be disconnected from the body.

24. The connector apparatus of claim 19, further comprising a pin sliding along a channel disengageably attaching the member to the body, disengagement of the member allowing the second tube to be disconnected from the body.

25. A method of connecting together multiple tubes, the method comprising:
(a) inserting a first tube over a male end of a polymeric connector;
(b) inserting a second tube of metallic material inside a female end of the polymeric connector in a substantially linear manner with less than half the insertion force being required as compared to the extraction force required to linearly pull out the second tube from the assembled connector;
(c) sealing the second tube within the polymeric connector such that the opening of the second tube is aligned with a through-bore of the male end;
(d) securing the tubes to the polymeric conhector without requiring a heated coupling; and
(e) allowing disengagement of the second tube from the connector through at least a rotational motion.

26. The method of claim 25, further comprising engaging inwardly and forwardly projecting teeth with the second tube inside the polymeric connector to deter removal of the second tube from the female end, a constant and nominal cylindrical section of the second tube engaging the teeth.

27. The method of claim 25, further comprising using a polymeric material for the first tube which is squeezed onto the male end of the polymeric connector which has a convoluted and irregular exterior surface.

28. The method of claim 26, further comprising allowing disengagement of the second tube from the polymeric connector by uncoupling a polymeric collar from the polymeric connector, part of the collar being externally accessible from a connector body even when the tubes are connected to the connector and part of the collar being internally located within the connector.

29. The method of claim 25, further comprising placing the tubes and polymeric connector in at least one of: a healthcare facility and a laboratory, and a flowing water through the tubes.
